(19) United States
(12) Patent Application Publication
(10) Pub. No.: US 2013/0069802 A1
(43) Pub. Date: Mar. 21, 2013

(54) CAR ACCIDENT AUTOMATIC EMERGENCY SERVICE ALERTING SYSTEM

(71) Applicants: Amir FOGHEL, Lehavim (IL); Oded Hogeg, Meitar (IL); Moshe Hogeg, Meitar (IL)

(72) Inventors: Amir FOGHEL, Lehavim (IL); Oded Hogeg, Meitar (IL); Moshe Hogeg, Meitar (IL)

(73) Assignee: AMOTECH LTD., Meitar (IL)

(21) Appl. No.: 13/237,355

(22) Filed: Sep. 20, 2011

(51) Int. Cl. G08G 1/123; B60Q 1/00

(52) U.S. Cl. 340/989; 340/436

(57) ABSTRACT

A system for detecting a car accident and alerting emergency forces to an accident, including a smart mobile device having an accelerometer, a GPS unit, a processor connected thereto. The processor receives real time readings of measurement values received from the accelerometer and the GPS unit, runs a dedicated application to detect the occurrence of a car accident according to the readings received within a period of time, and generates an alert signal when an accident is detected. The system also includes a memory connected to the accelerometer, the GPS unit and the processor, to store the measurement values and information for a predetermined period of time, and a transmitter connected to the processor and the memory to send the alert signal and the measurement values and information stored within the memory. The system also includes a base station including a receiver, and a unit for alerting emergency forces.

### FIELD OF THE INVENTION

The present invention relates to the field of alerting systems. More particularly, the present invention relates to a system that enables detecting a car accident and alerting emergency services in case a car accident is detected.

### BACKGROUND OF THE INVENTION

More than one million people are killed each year in car accidents all over the world, more than three thousand each day. About 30% of those people die within the first ten minutes from the time of the car accident. Car accidents which occur in uninhabited areas, locations far from urban locations, non-busy roads located in remote locations, are at further risk due to the fact that:
a) It could take a long time for a passing car to pass by and call for emergency services.
b) It could take a long time for the emergency services to arrive and evacuate the injured to a hospital.

Several incidents have occurred wherein the call for help occurred only an hour from the time of injury. In some cases, the call for help occurred several hours after injury.

As it is known, regarding receiving medical treatment, every second can be crucial to whether an injured person will live or die. Time can be also crucial for an injured person to whether or not his injury will be permanent or not. Even a person involved in a car accident in a city needs immediate medical attention and immediate evacuation to a hospital. Thus an immediate call for help can save his life.

U.S. Pat. No. 6,397,133 teaches of a system for prevention of accidents and/or in the event of such an accident notifies emergency forces. However, this publication does not teach of such a system with the use of a common smart phone and requires equipment connected to the vehicle elements such as vehicle sensors.

US 2005/0037730 teaches of a mobile phone with capabilities of alerting in case of emergency events, such as theft and accidents. However, it doesn't teach of a system comprising a smart application that calculates real time motion, acceleration and location parameters and determines an accident according to said parameter threshold values.

It is therefore an object of the present invention to provide a method and means for automatically determining a car accident according to real time calculations of motion, acceleration and location parameters and alerting medical emergency services in case a car accident is detected.

It is a further object of the present invention to provide such method and means utilizing a common smart electronic device such as a cell phone.

Other objects and advantages of the present invention will become apparent as the description proceeds.

### SUMMARY OF THE INVENTION

The present invention relates to a system and method for detecting a car accident and alerting emergency forces for rescuing injured people involved. The system comprises a smart mobile device such as a smart phone. The smart device comprises processing means adapted to run a dedicated application for detecting the occurrence of a car accident. The application receives real time readings of measurement values received from an accelerometer built in the smart device and a GPS unit built in the smart device.

The application determines if an accident has occurred according to a plurality of events taking place wherein the events can depend upon:
a. The acceleration measurements received from the accelerometer exceeding a predetermined threshold value;
b. The location latitude and/or longitude and/or altitude measurements received from the GPS unit changing or exceeding a predetermined threshold within a predetermined period of time.
c. The speed measurements received from the GPS unit changing or exceeding a predetermined threshold within a predetermined period of time.

Once the determination of the accident is made, the smart device sends an alert signal to a remote base station via cellular communication or Wi-Fi etc. An operator at the base station receives the alert signal along with the smart device acceleration, location and speed measurements data from a predetermined time point before the occurrence of the accident until a certain time after the time of accident, wherein this data has been stored in a memory unit in the device. The operator operates according to the received data and alerts rescue forces accordingly.

The invention relates to a system for detecting a car accident and alerting emergency forces in case an accident is detected wherein the system comprises:
a smart mobile device comprising:
   a. an accelerometer;
   b. a GPS unit;
   c. processing means connected to said accelerometer and said GPS unit such that said processing means are adapted to receive real time readings of measurement values received from said accelerometer and said GPS unit;
      wherein said processing means are adapted to run a dedicated application to detect the occurrence of a car accident according to said readings received within a period of time;
      and wherein said processing means are adapted to generate an alert signal when an accident is detected;
   d. memory means connected to said accelerometer, said GPS unit and said processing means, said memory means is adapted to store said measurement values and information for a predetermined period of time;
   e. sending means connected to said processing means and said memory means, adapted to send said alert signal and said measurement values and information stored within said memory means;
a base station comprising:
   a. receiving means for receiving the data sent from said sending means;
   b. means for alerting emergency forces.

Preferably, the system smart mobile device is a smart phone.

Preferably, the system processing means is a microcontroller.

Preferably, the system memory means is the user directory of the smart phone.

Preferably, the system memory means is a log.

Preferably, the system receiving means is a server.

Preferably, the system means for alerting emergency forces consists from the group of
a. a phone;
b. a computer with an internet connection;
c. a radio transmitter.

Preferably, the system device further comprises a compass connected to the memory means, said memory means are adapted to store said compass orientation measurement values for a predetermined period of time.

The present invention relates to a system for detecting a car accident and alerting emergency forces in case an accident is detected wherein the system comprises:
a smart mobile device comprising:
   a. a GPS unit;
   b. processing means connected to said GPS unit such that said processing means are adapted to receive real time readings of measurement values received from said GPS unit;
      wherein said processing means are adapted to run a dedicated application to detect the occurrence of a car accident according to said readings received within a period of time;
      and wherein said processing means are adapted to generate an alert signal when an accident is detected;
   c. memory means connected to said GPS unit and said processing means, said memory means is adapted to store said measurement values and information for a predetermined period of time;
   d. sending means connected to said processing means and said memory means, adapted to send said alert signal and said measurement values and information stored within said memory means;
a base station comprising:
   a. receiving means for receiving the data sent from said sending means;
   b. means for alerting emergency forces.

The present invention also relates to a method for operating and using said system.

### BRIEF DESCRIPTION OF THE DRAWINGS

The present invention is illustrated by way of example in the accompanying drawings, in which similar references consistently indicate similar elements and in which:

FIG. 1 illustrates an embodiment of the main components of the system of the present invention.

FIGS. 2a 2b and 2c illustrate embodiments of a functionality flow chart of the operation of an application of the present invention.

FIG. 3 illustrates another embodiment of a functionality flow chart of the operation of an application of the present invention.

### DETAILED DESCRIPTION OF THE INVENTION

The present invention relates to a system that enables automatic tracking of a car, detection of car accidents and alerting emergency services (in case an accident is detected) for the quick evacuation of injured people involved in car accidents. The system enables identification of the occurrence of a car accident by means of a dedicated application installed within a smart mobile device such as a smart cellular phone, and enables the automatic immediate alerting of emergency services to the location of the accident.

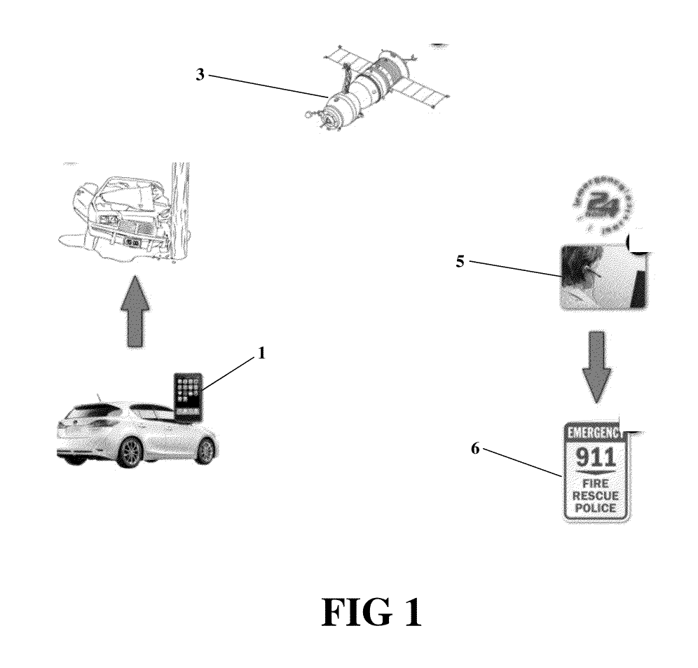

The system comprises a smart mobile device such as a smart cell phone 1 (shown in FIG. 1) comprising a dedicated application that enables to identify a car accident, as will be explained hereinafter. An example of such smart cell phone is an Apple iPhone such as model number: A1303, Samsung Galaxy S2, model number:i9100. The smart phone 1 further comprises GPS means.

The system further comprises a base station 5 that is capable of receiving an emergency alert signal from the smart phone 1, in case of a car accident. The data received in the base station 5 includes the identity of the smart phone holder along with the parameters of the smart phone exact location. An operator at the base station can then alert emergency services 6 informing them of the exact location of the accident. Once the identity of the smart phone holder is received the data of the smart phone holder stored in a database can be displayed for the operator's viewing so that the operator can act accordingly.

The smart phone comprises a built in accelerometer. An example of such accelerometer can be a STMicroelectronics LIS302DL accelerometer. The accelerometer constantly measures the acceleration of the smart phone (or of the vehicle the smart phone is located in). The accelerometer is preferably a triaxial accelerometer capable of measuring the acceleration of the smart phone in three dimensions—the projection of the total acceleration vector on the X-axis, the Y-axis and the Z-axis. It can also calculate the magnitude and direction of the total vector comprised of The X axis projection, the Y-axis projection and the Z-axis projection:

### ACC_VECTOR(X_value, Y_value, Z_value).

The smart phone further comprises a built in GPS unit such as a BROADCOM BCM4750 GPS unit. The GPS unit is in constant transmitting and receiving connection with a satellite 3 of a GPS system capable of measuring the location of the smart phone 60 times a minute. The GPS unit is capable of calculating the velocity of the smart phone motion according to the location measurements, as known in the art. The mobile device calculates the moving speed of the device, the driving speed in case the device is in a car, by calculating the movement (location change) from point to point of the GPS locations as a function of time. The GPS unit is also capable of measuring the altitude location of the smart phone (60 times a minute), thus measuring the longitude, latitude and altitude exact location of the smart phone mobile device.

As known in the art, the acceleration of a free falling subject in accordance with the gravity on earth is approximately:

G=˜9.81 m/sec² (depending on the exact location on earth)

A natural high acceleration of a car can reach about 0.5 g (˜4.905 m/sec²) and even more. The natural high acceleration of a motorcycle can reach about 1 g. Any acceleration higher than these accelerations can indicate a collision between vehicles causing the high acceleration or a collision between a car and a pedestrian possessing or holding the smart phone.

The system operates in a car accident detection mode. The GPS unit constantly measures the location of the smart phone (in longitude, latitude and altitude). The accelerometer constantly measures the acceleration of the smart phone.

As known in the art a slowdown is calculated as a negative acceleration. In case of an emergency slowdown of a vehicle, the slowdown acceleration can reach between (−0.7 g) and (−0.9 g). In extreme cases the vehicle can reach (−1.2 g). The calculation of (−1.8 g), for example, could indicate a car accident. Preferably the accelerometer calculates the absolute value of the acceleration/slowdown and if the absolute value is above a predetermined threshold then it could indicate a car accident.

During a car accident the acceleration of a car or a person can rapidly increase or decrease. If a car hits a pedestrian the pedestrian is thrown and accelerates at once to the speed of the hitting car. If a car hits a concrete wall the negative acceleration (slowdown) will substantially increase. That is why the absolute value of the acceleration is measured to indicate any type of acceleration, whether it is an extreme acceleration or a sudden slowdown.

The smart phone comprises processing means such as a microprocessor such as (1) Cortex-A8 processor, PowerVR SGX535GPU, Apple A4 chipset, (2) Dual-core 1.2 GHz ARM Cortex-A9 processor, Mali-400 MP GPU, Orion chipset (3) 1.2 GHz dual-core processor, Adriano 220 GPU, Qualcomm MSM 8260 Snapdragon. The processing means are connected to the GPS unit and to the accelerometer. The processing means are adapted to run a dedicated application, which enables a unique function of detecting the occurrence of a car accident. When the application runs, the processing means receive real time readings of measurement values from the GPS unit (location, speed) and real time readings of measurement values from the accelerometer (acceleration value readings), to which the processing means are connected to. According to the readings received within a period of time the application can determine whether or not an accident has occurred. As known in the art the dedicated application is fit to measure time, compare values, perform calculations, etc.

In a preferred embodiment of the present invention the system operates as follows. The accelerometer constantly measures the acceleration of the smart phone. If the acceleration (on one or more of the three axis's or the magnitude of the total acceleration vector) of the smart phone reaches a predetermined threshold the application of the smart phone operates the system according to an elimination step phase. Regarding the predetermined acceleration threshold it is preferably 1.8 g (˜17.6 m/sec²). Any acceleration above this value will trigger the system.

The smart device comprises memory means such as the user directory of a smart phone which is memory space allocated for an application running on the device. The memory is used for data save for storing the device location, speed and acceleration for a predetermined period of time, preferably for 30 seconds.

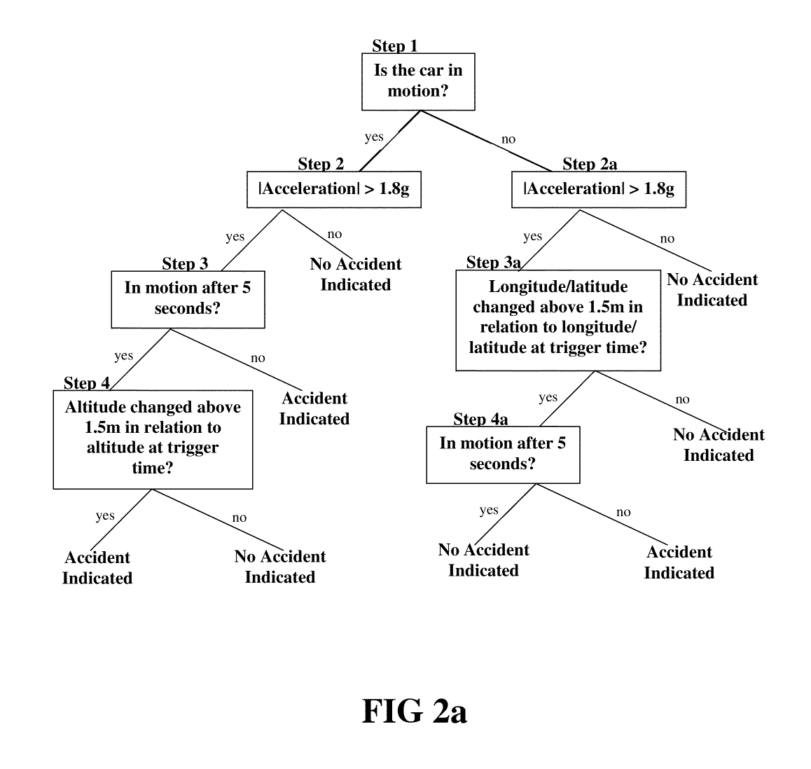

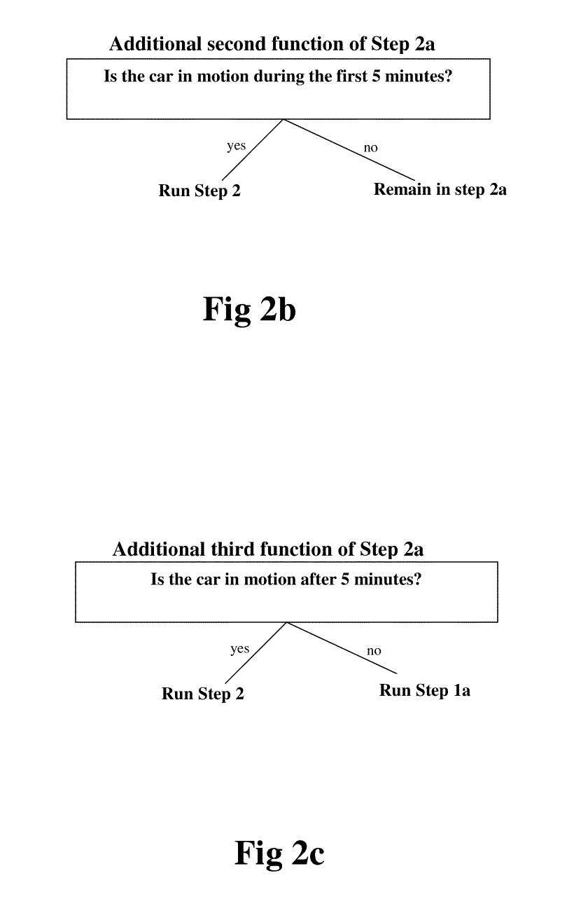

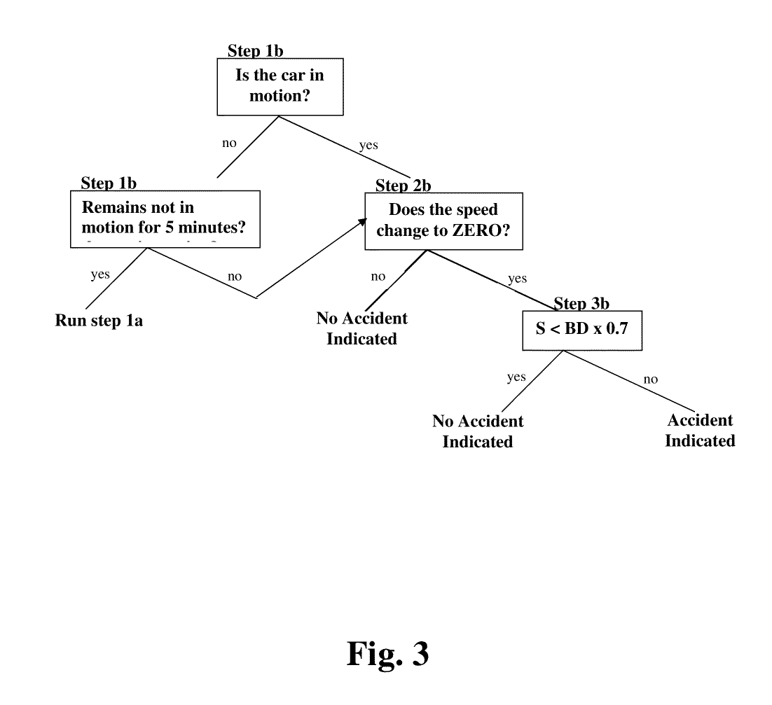

FIG. 2a shows a preferable step phase of the application which is run according to an embodiment of the present invention:

### Step 1

The application first runs step 1 of the application. According to step 1, the application constantly receives real time GPS unit measurements and checks if the device is in motion by constantly measuring the location of the device and checking if the location parameters change. For the purpose of clarification the “device in motion” is referred to also as the “car in motion”, wherein the device could also be placed in any other vehicle and wherein the system functions according to the location, speed, and acceleration of the device. If the car is in motion the application runs step 2 of the application. If the car is not in motion the application runs step 1a of the application.

### Step 1a

The application turns off the accelerometer and the GPS unit for power saving of the device. The application turns on the GPS every 1 minute to quickly check whether the car is back in motion or not. If the car is not back in motion the system remains in step 1a—“sleep mode” and checks again whether the car is in motion approximately 30 seconds later. If the car is back in motion the application runs step 2 of the application.

### Step 2

According to step 2 of the application, the application constantly receives the acceleration measurements from the accelerometer which constantly measures the acceleration of the smart phone. If the accelerometer reads normal acceleration values then no accident is indicated. If the acceleration reaches a predetermined threshold (i.e. if the absolute value is larger than the predetermined threshold e.g. 1.8 g) the application runs step 3 of the application. Hereinafter the time that the acceleration reaches the predetermined threshold is referred to as the “trigger time”.

If the application detects by means of the GPS unit that the car is not in motion, i.e. the speed equals zero, then the application runs step 2a of the application.

### Step 3

According to step 3 of the application, if the movement of the vehicle stops during the first 5 seconds after the trigger time an accident is indicated. If the vehicle remains moving even after the 5 seconds, the application runs step 4.

### Step 4

According to step 4 of the application, the application constantly receives the GPS unit measurements of the altitude of the car/device. According to the application it is determined whether or not the car altitude has changed more than 1.5 m in relation to the car altitude at the trigger time. If the measured absolute value is above 1.5 m then an accident is indicated. If not then no accident is indicated, and the application runs step 2 again.

### Step 2a

The car is indicated as being in a “standing” no motion condition. According to step 2a of the application, the application constantly receives the acceleration measurements from the accelerometer which constantly measures the acceleration of the car. If the accelerometer reads normal acceleration values then no accident is indicated and the application keeps running step 2a. If the acceleration reaches the predetermined threshold the application runs step 3a.

There is an additional second simultaneous function of step 2a wherein the application runs a timer and checks if the speed remains zero, during the first 5 minutes of the running of step 2a, as shown in FIG. 2b. If the car begins motion during the first 5 minutes of step 2a, the application runs step 2 (unless the motion includes an acceleration above the predetermined threshold in which case the application runs step 3a as explained above). If not, the application remains running step 2a.

There is yet an additional third function of step 2a. If after 5 minutes no motion is still detected, the application runs step 1a (the “Sleep mode”), as shown in FIG. 2c. If motion is detected exactly after 5 minutes the application runs step 2 again.

### Step 3a

According to step 3a of the application, the application constantly receives the GPS unit measurements of the car longitude and latitude location and the application determines whether or not the longitude/latitude has changed more than 1.5 m in relation to the car (device) longitude/latitude at the trigger time. If the measured absolute value is above 1.5 m then the application runs step 4a. If below 1.5 m, then no accident indicated and the application runs step 2a again.

### Step 4a

According to step 4a of the application, if the movement of the vehicle stops during the first 5 seconds after the trigger time an accident is indicated. If the car continues to move even after the 5 seconds, then no accident is indicated and the car runs step 2.

The location of the device is constantly measured. At all stages, if the device is not in motion for a predetermined period of time (such as 5 minutes), the device will run step 1a—the “sleep mode” and the accelerometer and GPS unit will cease to measure the acceleration and GPS data respectively, for battery conservation. On the other hand the GPS turns on every minute and checks if the car is in motion. Once the device is in motion again, the accelerometer is activated again and step 2 is run again.

According to another embodiment of the present invention, the system can work in an additional mode. In order to conserve energy in the device and in order to enable the running of additional applications on the device in an efficient power conservation manner, the device can optionally work in a “Background Status” mode. Optionally, the system can change its working mode to the “Background Status” mode automatically when a phone call is received or when another application in the device is activated.

The “Background Status” mode comprises the following steps.

### Step 1b

The application constantly receives real time GPS unit measurements and checks if the device is in motion by constantly measuring the location of the device and checking if the location parameters change. The accelerometer is shut off for power saving.

If the car is not in motion the application runs a timer and checks if the speed remains zero, during the first 5 minutes of the running of step 1b. If no motion is detected during the 5 minutes the application runs step 1a. If motion is detected during the 5 minutes the application runs step 2b.

### Step 2b

The application constantly receives real time GPS unit measurements and checks the speed of the car. The GPS unit can calculate the speed of the car at each moment as well known in the art, based on dividing the distance in time. If the speed changes to ZERO (no movement), the application runs step 2b. During this “background mode”, the exact time that the speed changes to zero is the trigger time. If the car is still in motion, no accident is indicated and the application keeps running step 1b.

### Step 3b

The processor of the device runs a formula for calculating a “breaking distances” calculation.

The formula is:

BD(Breaking distance)=V²/(254×μs)

Wherein:

μs is the estimated coefficient of the static friction between the car and the road. The coefficient of the static friction is usually around 0.7.

V is the speed of the car exactly t1 seconds prior to the trigger time, wherein t is the trigger time. This speed is stored in the device memory as mentioned herein. In a most preferred embodiment t1=5 seconds.

After receiving the formula result, the result is multiplied by 0.7 giving a final result. The application checks if the final result exceeds S or not.

S<BD×0.7

S represents the actual distance that the device travels from time t1 until the trigger time t of the device. S is calculated by measuring the distances between the location measurements stored in the device memory from time t1 until the trigger time t of the device, and summing the distances. If the final result exceeds S, no accident is indicated and the application runs step 1b again. If the final result does not exceeds S, an accident is indicated.

The device can automatically return to the regular mode when the additional applications are terminated, e.g. when a phone call is terminated. Optionally the phone can always work on a “background” mode or return to regular mode according to the user's desire.

In any case (during any work mode) when an accident is indicated, an alert within the smart device is activated (generated by the processing means) allowing the driver/user to stop it manually in case of a false alarm by pressing a certain button on the device. If the alarm is not stopped manually by a predetermined time (e.g. 10 seconds) the smart device 1 will send the alert signal with all the information gathered within the past 30 seconds in the memory means to the base station for review and further actions usually calling emergency services. If the user stops the alert, the device will not send an alert to the base station. Optionally, upon determination of an accident, the processing means generate the alert signal and the smart device immediately sends the alert signal to the base station.

The memory means are connected to the GPS unit, the accelerometer and to the processing means. The measurement values and information in all the steps (location, speed and acceleration, indications, etc.) is stored in the memory means (e.g. a log) for a predetermined period of time, preferably for 30 seconds. When an accident is indicated and the device sends the alert signal, all the information stored in the memory means within the past predetermined period of time (preferably 30 seconds) is also sent to the base station such that an operator at the base station would be able to view the car movement, location, speed and acceleration from the time before the accident and during the accident.

In another embodiment of the present invention the device comprises a compass (preferably a digital compass) connected to the memory means. The direction-orientation of the device is constantly measured by the compass and readings delivered to the memory means. The orientation is measured preferably 60 times a minute. If the device is placed and fixed in a car, the change of the device orientation can indicate the change of the car orientation.

The orientation data is stored within the memory means for preferably 30 seconds as explained hereinabove. The data is also transferred to the base station in the same manner as explained hereinabove with regards to the location, speed and acceleration. When an alarm is triggered the operator at the base station can view the orientation of the car before, during and after the accident. The orientation of the car before, during and after the trigger time can further assist an operator to draw conclusions regarding whether an accident has occurred or not, in case it is unclear.

The smart device 1 comprises sending means (transmission means), connected to the processing means and memory means. The sending means are adapted to send the alert signal (generated by the processing means) and the memory saved within the memory means preferably to the base station server. The sending means send the information by means of the smart device 1 internet transmitted via a cellular network or Wi-Fi. Transmissions adapted for use with a smart cellular phone are also sufficient, as well known in the art. Preferably, the sending means are the transmission elements of the smart cell phone.

Preferably, if the information does not reach the base station (e.g. failure of transmission) the information is repeatedly sent until it is successfully received by the base station 5 whereby the device receives an acknowledgment signal that the sent information has been received at the base station. The base station is preferably a call center.

The base station 5 comprises receiving means such as a server. An operator at the base station 5 receives the accident signal (e.g. on the operator computer connected to the receiving means) from the receiving means and can read the user's data. The operator can also view the location of the smart phone 1, and the manner of how the accident was indicated. The base station has a unique program that can extract the memory data sent, read the data and show the accident information, i.e. the location data and motion of the device on a map according to the data received by the device. Optionally the receiving means is a cellular device adapted to receive an SMS message.

After viewing the accident parameters the operator can act according to discretion to finalize determination of a car accident. Optionally the operator can try to call and make contact with the smart phone user inquiring about the accident or whether it might have been a false alarm. If the user does not answer the smart phone or specifies that he needs help, the operator immediately calls for emergence forces or emergency medical services and directs them to the exact location of the accident. Such emergency forces can include police, ambulance services, firefighting services, evacuation helicopter services, etc., and external call centers connected to the aforementioned services.

The system comprises means so that the operator can make contact and alert emergency forces. Such alerting means can be a phone, a computer with an Internet connection, a radio transmitter, etc., and accordingly the connection can be by phone line/cellular network, Internet connection, radio network, etc. Optionally, a base station computer/device can receive the signal and automatically alert emergency services without requiring an operator. For example, a receiving server can automatically send an emergency call to emergency forces immediately after it receives the alert signal by internet (or any of the manners mentioned hereinabove). The computer/device can also send to the emergency services the exact location of the accident.

The present invention system is very useful in many scenarios. The smart phone can be in the user's pocket and provide its alerting functionality in case of an accident whether the user is a pedestrian, a car driver, a car passenger, a bus passenger, a train passenger, etc. The smart phone can also be placed in the vehicle, in a purse, in the glove compartment, fixed on a device holder, etc. When using the present invention there is no need for a device built in the vehicle.

The present invention is very advantageous because it can provide the rescue emergency service forces with the exact location of the injured smart phone user. If an accident occurs on a road, a person calling for help doesn't know the exact location, and could have trouble describing the location of the accident, what could result in the delay of the rescue forces. Also a person calling for help at the scene of the accident can be very hysterical and cannot communicate effectively with the emergency forces, what can cause a further delay. On the other hand the operator according to the present invention functions in a skilled, calm and most effective manner.

The present invention is very useful also in case of a hit and run accident, where the smart device holder can be injured alone and the present invention system will send for the emergency service rescue.

Also, if the smart phone user is in shock or the like, and the operator calls the smart phone and the user answers, the operator can assist in providing preliminary guidelines to the injured user while the emergency services are on their way.

The smart phone comprises a display screen wherein optionally, according to the application function, the current device location, and speed can be displayed. The smart phone comprises a manual S.O.S input means (e.g. button) for activating the alert in case he is of need of emergency medical assistance or in case he is at an accident scene, etc. The smart phone also comprises a manual deactivating input means (e.g. button) for deactivating the alert in case of a false alarm. Optionally an audio alerting sound can be sounded from the smart phone when the car accident alert is activated.

The present invention further relates to a method for detecting a car accident and alerting emergency forces in case an accident is detected as explained hereinabove in relation to the invention system.

The present invention relates to a method for detecting a car accident and alerting emergency forces in case an accident is detected, wherein said method comprises the steps of:
a. measuring the acceleration, speed and location of a mobile device within;
b. storing the measurements throughout a predetermined period of time;
c. analyzing the measurements if they exceed a predetermined value throughout a period of time, according to an application;
d. determining if a car accident has occurred;
e. sending the indication and the measurements stored to a remote base station, if a car accident is indicated;
f. receiving said indication and measurements, by said base station;
g. alerting emergency services and directing them to the location of said device.

In a preferred embodiment after step f, of the above method, there is a step of analyzing received data by an operator to finalize determination of a car accident.

In a preferred embodiment, the speed, determined in step a of the method, is greater than zero and the acceleration, determined in step a, is greater than 1.8 g, and the determination, in step d, of whether an accident has occurred is deemed to be positive in cases wherein the device is in motion after five seconds from the time the acceleration exceeded 1.8 g, and wherein the altitude of the device changed above 1.5 m in relation to the device altitude at the time the acceleration exceeded 1.8 g.

In a preferred embodiment, the speed, determined in step a of the method, is equal to zero and the acceleration, determined in step a, is greater than 1.8 g, and the determination, in step d, of whether an accident has occurred is deemed to be positive in cases wherein the longitude/latitude of the device has changed more than 1.5 m in relation to the device longitude/latitude at the time the acceleration exceeded 1.8 g, and wherein the car is not in motion after five seconds from the time the acceleration exceeded 1.8 g.

The further invention relates to a method for detecting a car accident and alerting emergency forces in case an accident is detected, wherein said method comprises the steps of:
a. measuring the speed and location of a mobile device;
b. storing the measurements throughout a predetermined period of time;
c. analyzing the measurements if they exceed a predetermined value throughout a period of time, according to an application;
d. determining if a car accident has occurred;
e. sending the indication and the measurements stored to a remote base station, if a car accident is indicated;
f. receiving said indication and measurements, by said base station;
g. alerting emergency services and directing them to the location of said device.

In a preferred embodiment, the speed, determined in step a of the above method is equal to zero, and the determination, in step d, of whether an accident has occurred is deemed to be positive in cases wherein the following condition is met,

S<(V²/(254×μs))×0.7
wherein V is the speed of the device measured t1 seconds prior to the time the speed equaled to zero;
wherein μs is the estimated coefficient of the static friction between the car and a road;
wherein S is the sum of distances between the location measurements of step a, during the t1 second prior to the speed equaling zero.

In a preferred embodiment the t1 seconds prior to the time the speed equaled to zero is 5 seconds.

In a preferred embodiment, μs=0.7 or μs=0.65.

While some of the embodiments of the invention have been described by way of illustration, it will be apparent that the invention can be carried into practice with many modifications, variations and adaptations, and with the use of numerous equivalents or alternative solutions that are within the scope of a person skilled in the art, without departing from the spirit of the invention, or the scope of the claims.

1. A system for detecting a car accident and alerting emergency forces in case an accident is detected wherein the system comprises:
a smart mobile device comprising:
a. an accelerometer;
b. a GPS unit;
c. processing means connected to said accelerometer and said GPS unit such that said processing means are adapted to receive real time readings of measurement values received from said accelerometer and said GPS unit;
wherein said processing means are adapted to run a dedicated application to detect the occurrence of a car accident according to said readings received within a period of time;
and wherein said processing means are adapted to generate an alert signal when an accident is detected;
d. memory means connected to said accelerometer, said GPS unit and said processing means, said memory means is adapted to store said measurement values and information for a predetermined period of time;
e. sending means connected to said processing means and said memory means, adapted to send said alert signal and said measurement values and information stored within said memory means;
a base station comprising:
a. receiving means for receiving the data sent from said sending means;
b. means for alerting emergency forces.

2. The system according to claim 1, wherein the smart mobile device is a smart phone.

3. The system according to claim 1, wherein the processing means is a microcontroller.

4. The system according to claim 2, wherein the memory means is the user directory of the smart phone.

5. The system according to claim 1, wherein the memory means is a log.

6. The system according to claim 1, wherein the receiving means is a server.

7. The system according to claim 1, wherein the means for alerting emergency forces consists from the group of
a. a phone;
b. a computer with an internet connection;
c. a radio transmitter.

8. The system according to claim 1, wherein the device further comprises a compass connected to the memory means, said memory means are adapted to store said compass orientation measurement values for a predetermined period of time.

9. A system for detecting a car accident and alerting emergency forces in case an accident is detected wherein the system comprises:
a smart mobile device comprising:
a. a GPS unit;
b. processing means connected to said GPS unit such that said processing means are adapted to receive real time readings of measurement values received from said GPS unit;
wherein said processing means are adapted to run a dedicated application to detect the occurrence of a car accident according to said readings received within a period of time;
and wherein said processing means are adapted to generate an alert signal when an accident is detected;
c. memory means connected to said GPS unit and said processing means, said memory means is adapted to store said measurement values and information for a predetermined period of time;
d. sending means connected to said processing means and said memory means, adapted to send said alert signal and said measurement values and information stored within said memory means;
a base station comprising:
a. receiving means for receiving the data sent from said sending means;
b. means for alerting emergency forces.

10. A method for detecting a car accident and alerting emergency forces in case an accident is detected, wherein said method comprises the steps of:
a. measuring the acceleration, speed and location of a mobile device within;
b. storing the measurements throughout a predetermined period of time;
c. analyzing the measurements if they exceed a predetermined value throughout a period of time, according to an application;
d. determining if a car accident has occurred;
e. sending the indication and the measurements stored to a remote base station, if a car accident is indicated;
f. receiving said indication and measurements, by said base station;
g. alerting emergency services and directing them to the location of said device.

11. The method according to claim 10, further comprising, after step f, a step of analyzing received data by an operator to finalize determination of a car accident.

12. The method according to claim 10, wherein the speed, determined in step a, is greater than zero and wherein the acceleration, determined in step a, is greater than 1.8 g, and wherein the determination, in step d, of whether an accident has occurred is deemed to be positive in cases wherein the device is in motion after five seconds from the time the acceleration exceeded 1.8 g, and wherein the altitude of the device changed above 1.5 m in relation to the device altitude at the time the acceleration exceeded 1.8 g.

13. The method according to claim 10, wherein the speed, determined in step a, is equal to zero and wherein the acceleration, determined in step a, is greater than 1.8 g, and wherein the determination, in step d, of whether an accident has occurred is deemed to be positive in cases wherein the longitude/latitude of the device has changed more than 1.5 m in relation to the device longitude/latitude at the time the acceleration exceeded 1.8 g, and wherein the car is not in motion after five seconds from the time the acceleration exceeded 1.8 g.

14. A method for detecting a car accident and alerting emergency forces in case an accident is detected, wherein said method comprises the steps of:
a. measuring the speed and location of a mobile device;
b. storing the measurements throughout a predetermined period of time;
c. analyzing the measurements if they exceed a predetermined value throughout a period of time, according to an application;
d. determining if a car accident has occurred;
e. sending the indication and the measurements stored to a remote base station, if a car accident is indicated;
f. receiving said indication and measurements, by said base station;
g. alerting emergency services and directing them to the location of said device.

15. The method according to claim 14, wherein the speed, determined in step a, is equal to zero, and wherein the determination, in step d, of whether an accident has occurred is deemed to be positive in cases wherein the following condition is met,
S<(V²/(254×μs))×0.7
wherein V is the speed of the device measured t1 seconds prior to the time the speed equaled to zero;
wherein μs is the estimated coefficient of the static friction between the car and a road;
wherein S is the sum of distances between the location measurements of step a, during the t1 second prior to the speed equaling zero.

16. The method according to claim 15 wherein the t1 seconds prior to the time the speed equaled to zero is 5 seconds.

17. The method according to claim 15 wherein μs=0.7.

18. The method according to claim 15 wherein μs=0.65.

19. The system according to claim 1, wherein the base station sending means is adapted to automatically alert emergency services immediately after said base station receiving means receive the alert signal.
